(19) United States
(12) Patent Application Publication
(10) Pub. No.: US 2010/0122612 A1
(43) Pub. Date: May 20, 2010

(54) Pipe Wrench

(75) Inventors: James A. Kovach, Parma, OH (US); John R. Hickman, North Canton, OH (US)

Correspondence Address: JEANNE E. LONGMUIR, 2836 CORYDON ROAD, CLEVELAND HEIGHTS, OH, 44118, US

(73) Assignee: SUPERIOR TOOL CORPORATION, Cleveland, OH (US)

(21) Appl. No.: 12/619,477

(22) Filed: Nov. 16, 2009

Related U.S. Application Data
(60) Provisional application No. 61/114,912, filed on Nov. 14, 2008.

(51) Int. Cl. B25B 23/16

(52) U.S. Cl. 81/177.1

(57) ABSTRACT

A pipe wrench or tool with an improved I-beam handle design having a ramped or tapered cross-sectional configuration, as well as an optional stronger ductile iron material. Specifically, the portion of the tool handle adjacent the jaw or tool operating portion, has wider flanges in the I-beam configuration than the flanges in the opposite end of the tool handle. Such a design adds additional strength at what are typically critical stress areas of the tool handle. The use of the present handle design, along with the use of a stronger ductile iron material, as disclosed here, provides wrenches using these features with a substantial improvement in tool strength as compared to conventional tools.

### CROSS-REFERENCE TO RELATED APPLICATIONS

The present application claims priority from U.S. Patent Application Ser. No. 61/114,912 filed Nov. 14, 2008, the entire subject matter of which is incorporated herein by reference.

### FIELD OF INVENTION

The present application is directed to an improved pipe wrench, and more particularly to a tool handle having improved strength without increased weight.

### BACKGROUND

A variety of pipe wrench designs are well known. Prior pipe wrench designs have made use of a solid handle design with a substantially uniform handle cross-section which fully fits within the closed hand of the user during use of the wrench. Such uniform handle cross-sections provide the handle with the necessary weight and strength to perform the desired tasks. However, under certain conditions, a stronger tool may be desired for better tool performance.

In many prior art wrench designs, the standard material used is a cast ductile iron material. The material is generally inexpensive, and provides the cast tool with the strength to resist deformation and assist the user with pipe movement during use of the tool. However, under more difficult operating conditions, a stronger tool capable of increased performance, is desired. Where such additional performance is desired, the prior art tools developed to meet the increased performance expectations have used additional standard ductile iron material, which has resulted in a heavier tool which may be more difficult to use.

### SUMMARY OF THE INVENTION

The pipe wrench or tool disclosed here has an improved I-beam handle design with a ramped or tapered cross-sectional configuration and/or a stronger iron material. Specifically, the portion of the tool handle adjacent the jaw or tool operating portion, has wider flanges in the I-beam configuration than the flanges in the opposite end of the tool handle.

The present application provides an improved I-beam tool handle design which provides a 50% increase in the strength of the tool during use over conventional tools having the prior art handle design, without the addition of more material, or any resulting weight, to the tool or tool handle.

### DESCRIPTION OF THE DRAWINGS

FIG. 1 is a schematic, perspective view of the improved pipe wrench of the present application, which shows the improved handle design in solid and the fixed and movable jaws in phantom.

FIG. 2 is a schematic, partial perspective view of the handle of the improved pipe wrench of the present application.

FIG. 3 is a side view of the handle of the improved pipe wrench of the present application.

FIG. 3B is a cut away view of the handle of FIG. 3 taken along the line B-B.

FIG. 3C is a cut away view of the handle of FIG. 3 taken along the C-C.

FIG. 3D is a cut away view of the handle of FIG. 3 taken along the D-D.

FIG. 3F is a cut away view of the handle of FIG. 3 taken along the F-F.

FIG. 3G is a cut away view of the handle of FIG. 3 taken along the G-G.

FIG. 4 is a top view of the handle of FIG. 3.

FIG. 4E is a cut away view of the handle of FIG. 4 taken along the E-E.

FIG. 5 is a partial, cut away view of the section A shown in FIG. 3.

### DETAILED WRITTEN DESCRIPTION OF THE INVENTION

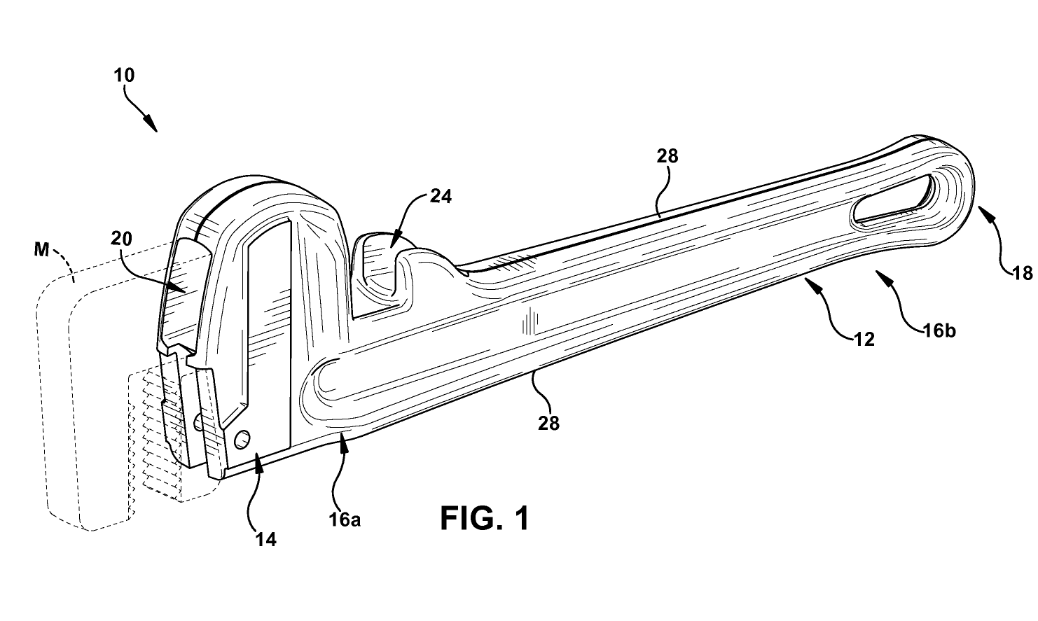

As shown in FIGS. 1 to 5, the pipe wrench or tool 10 disclosed here has an improved I-beam handle 12 design with a ramped or tapered cross-sectional configuration, as well as an optional stronger iron material. Specifically, the portion of the tool handle 12 adjacent the jaw or tool operating portion 14, has wider flanges 16a in the I-beam configuration than the flanges 16b in the opposite end of the tool handle 12. Such a design adds additional strength at what are typically critical stress areas of the handle 12. The use of the present handle 12 design, along with the use of a stronger ductile iron material, as disclosed here, provides pipe wrenches or other tools using these features with a substantial improvement in tool strength as compared to conventional tools.

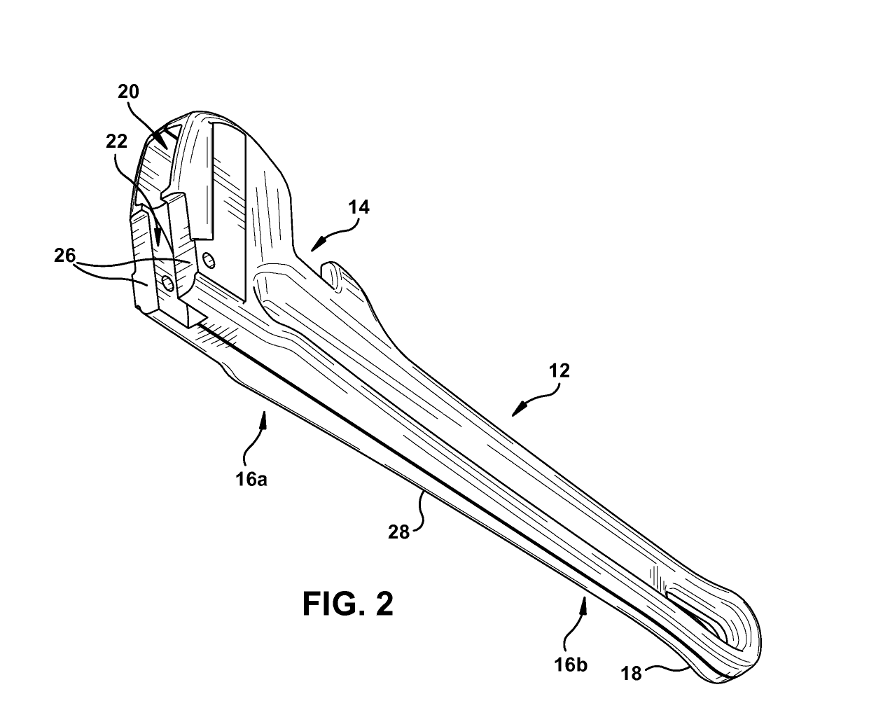

As shown in FIGS. 1 and 2, a tool handle 12 for a pipe wrench tool is provided with an opening 20 for receiving a movable jaw M, as well as an opening 22 for receiving a fixed jaw F. The fixed jaw F is generally secured within the tool handle 12 via conventional fastening means within jaw receiving flanges 26. An access opening 24 is also provided for receiving a threaded adjustment member which is engaged with the movable jaw M to expand and retract the movable jaw M with respect to the fixed jaw F.

Turning to the detail of the handle 12, the flange 16a is ramped or tapered from a wider dimension near the jaw or tool operating portion 14 to a narrow dimension 16b near the distal end 18 of the tool handle 12. FIG. 4 illustrates the ramping or tapering of the improved handle 12 design. In particular, FIG. 4 illustrates that at its widest dimension, the flange portion 16a of the I-beam near the jaw portion 14 of the handle, is at least as wide as the jaw portion 14 of the handle. As shown in the embodiment of FIG. 4, the widest dimension of the flange portion 16a, is in fact slightly wider than the width of the jaw portion of the handle, or the external dimension of the jaw receiving flanges 26 for the fixed jaw F. The improved I-beam handle 12 design also provides that the edges 28 of the I-beam formed by the flanges are rounded to comfortably engage the user's hand.

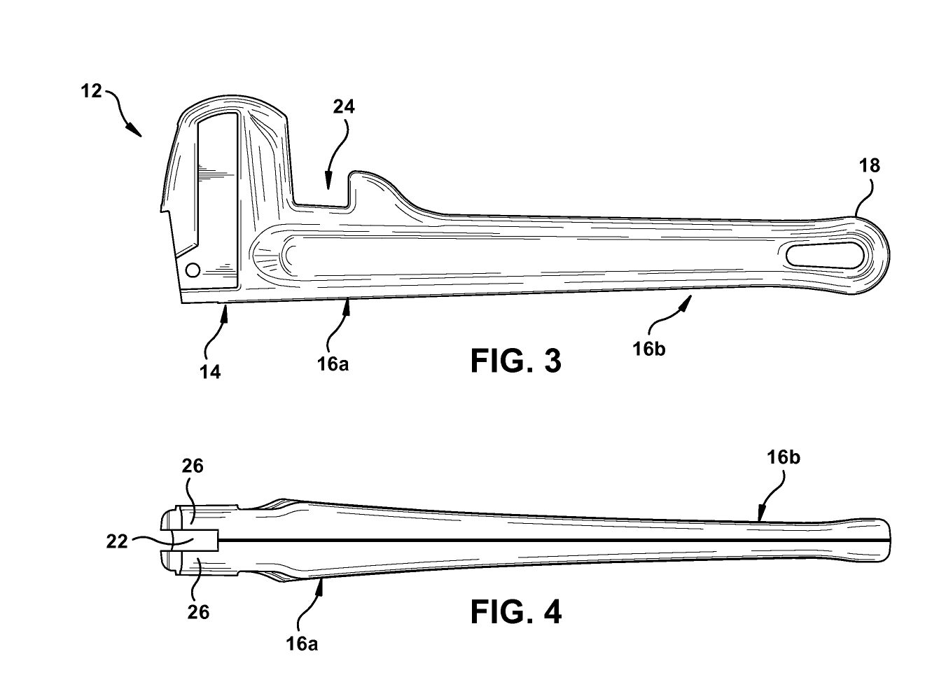

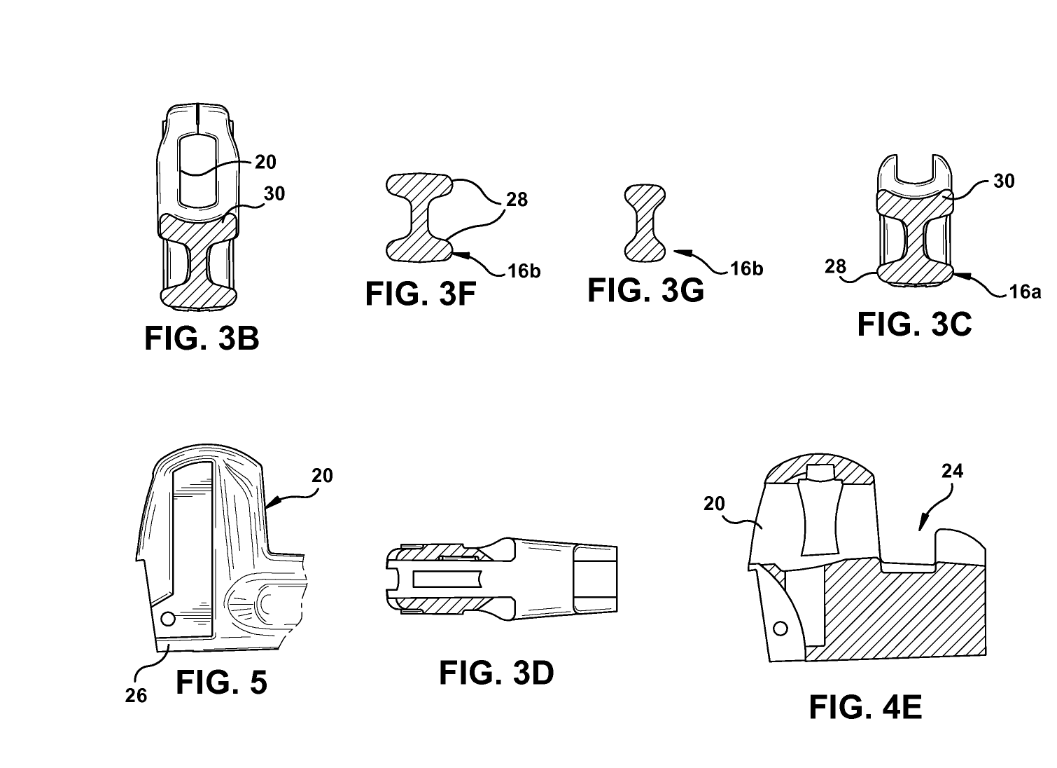

Still further, as shown in FIGS. 1-2 and FIGS. 3B, 3C, 3F and 3G, the flanges 16 of the present I-beam tool handle 12 design have a changing tapered or ramped wedge shape in cross-section, moving from the jaw end 14 of the tool handle to the distal end 18 of the tool handle. As shown, the cross-sectional shape of the I-beam flange varies near the jaw end 14 of the handle, in that the flange 16a is wider along the interior of the tool, as shown in FIGS. 3B and 3C, as compared to FIG. 3F. Generally, the cross-sectional shape of the handle has a varied bow-tie shaped configuration, as is also shown in FIGS. 3B, 3C, 3F and 3G. At the section of the handle near the opening 20 for receiving the movable jaw M, the bow-tie shape on the portion near the jaw opening and access opening 24 for the threaded member, the handle 12 has a concave surface 30, as best seen in FIGS. 3B and 3C.

Additionally, the present tool handle design may be manufactured from an improved and generally more expensive material, such as QT800-2 ductile iron, which is commercially available from sources such as Helkey Enterprises Inc. of Canada. This preferred material of one embodiment, has increased strength properties over standard ductile iron, which in the I-beam handle 12 design of the present application enables the tool 10 to have approximately the same weight as pipe wrenches of comparable size and capacity, but also to attain the desired increased performance characteristics. Such performance characteristics can be particularly important when dealing with heavy or deteriorated pipe, for example. The chart illustrated below provides weight comparisons for a variety of tool sizes having the present embodiment with the I-beam design and using the more expensive ductile iron material.

| | Pipe Capacity | Pipe Capacity | Weight | Weight |
|---|---|---|---|---|
| Tool Size | (inch) | (mm) | (lbs) | (kgs) |
| 8″ Heavy Duty | 1 | 30 | 0.95 | 0.43 |
| 10″ Heavy Duty | 1½ | 48 | 1.9 | 0.86 |
| 14″ Heavy Duty | 2 | 60 | 3.9 | 1.77 |
| 18″ Heavy Duty | 2½ | 75 | 5.5 | 2.49 |
| 24″ Heavy Duty | 3 | 90 | 9.26 | 4.2 |
| 36″ Heavy Duty | 5 | 140 | 20.36 | 9.24 |
| 48″ Heavy Duty | 6 | 165 | 36.1 | 16.37 |

Alternatively, where an even lighter weight tool is desired, while still retaining the increased strength performance characteristics, the I-beam handle design of the present pipe wrench tool handle 12 may also be of aluminum or an aluminum alloy material. The addition of the I-bean design in the tool handle 12 provides additional strength at a critical stress area of the tool handle making wrenches with the present design considerably stronger (by a factor of 50%) than their prior art counterparts.

It should be noted that the handle 12 of the illustrated tool 10 may be interchangeable with other manufacturers' pipe wrench components. The tool 10 may be provided with a durable epoxy powder-coated finish.

While an embodiment of the invention has been described in detail herein, it will be appreciated by those skilled in the art that various modifications and alternatives to the embodiment could be developed in light of the overall teachings of the disclosure. Accordingly, the particular device and arrangements are illustrative only and are not limiting as to the scope of the invention which is to be given the full breadth of any and all equivalents thereof.

We claim:

1. An improved pipe wrench tool having a handle portion with a jaw portion and a distal end spaced from the jaw portion, wherein the handle portion includes a flanged I-beam configuration and one flange of the I-beam is wider than the other along a portion of the handle adjacent the jaw portion.

2. The tool of claim 1, wherein the wider one flange is further configured to taper down in size so that the I-beam flanges of the handle portion are substantially equal in size at the distal end of the handle portion spaced from the jaw portion.

3. An improved tool handle having a flanged I-beam configuration wherein one flange of the I-beam is wider than the other at a portion of the handle adjacent the jaw and the wider flange is further configured to include a taper to a portion of the handle distal from the jaw.

4. The tool handle of claim 3, wherein the width of the I-beam flange at the portion of the handle adjacent the jaw is at least as wide as an external dimension of a jaw portion of the tool handle.

5. The tool handle of claim 3, wherein the handle portion is of lower weight, high performance ductile iron.

6. The tool of claim 1, wherein the handle portion is of lower weight, high performance ductile iron.

7. The tool handle of claim 3, wherein the flanged I-beam has a substantially bow-tie configuration in cross-section.

8. The tool of claim 1, wherein the flanged I-beam has a substantially bow-tie configuration in cross-section.
